(19) United States
(12) Patent Application Publication
(10) Pub. No.: US 2024/0370303 A1
(43) Pub. Date: Nov. 7, 2024

(54) SYSTEM AND METHOD FOR SEAMLESS OFFLOAD TO DATA PROCESSING UNITS

(71) Applicant: MELLANOX TECHNOLOGIES, LTD., Yokneam (IL)

(72) Inventors: Xiaolin Cao, Newtownabbey (IE); Robert Boyd, Ballymoney (IE); Mark Charles McMullan, Belfast (IE)

(21) Appl. No.: 18/141,605

(22) Filed: May 1, 2023

(51) Int. Cl. G06F 9/50

(52) U.S. Cl. CPC G06F 9/505; G06F 9/5044

(57) ABSTRACT

Systems and methods herein are for seamless offload of a workload to data processing units (DPUs), where one or more processing unit receive a selection of a first one of the plurality of DPUs to perform the workload, and perform a background operation to select second ones of the plurality of DPUs based, at least in part, on capabilities associated with the first one of the plurality of DPUs being within a threshold, where the workload is to be performed in a load balancing arrangement of the first one and second ones of the plurality of DPUs.

### TECHNICAL FIELD

At least one embodiment pertains to seamless offload for load balancing in computer networks. For example, load balancing using data processing units (DPUs) is performed at a library level, based in part on capabilities of a select one of the DPUs being within a threshold.

### BACKGROUND

Load balancing in a computing environment refers to an approach for distributing workload, such as network traffic or a process, to multiple constituent components, such as to CPUs or to entire host machines. This is to ensure that no single component is overwhelmed and to optimize resource utilization pertaining to such components. Further, load balancing can be achieved in different approaches including by round-robin load balancing, where incoming workload portions may be distributed evenly among a group of components in a cyclic order, with each component receiving an equal number of workload portions before a cycle repeats. Weighted load balancing includes assigning different weights to each component based on its capacity and performance with some components receiving a larger proportion of workload portions, whereas least-connection load balancing ensures that workload portions are sent to components in a group that are the least active. Further, internet protocol (IP) hash-based load balancing uses component IP addresses to distribute workload portions across regions by a hash function that is used to map the IP addresses to the components. Load balancing in Nvidia's Datacenter-On-Chip Architecture (DOCA®) framework may be applied to data processing units (DPUs) that are capable of performing offloaded workloads from a central processing unit (CPU). The resulting arrangement has demonstrated limited throughput with demands for performance outstripping hardware specifications available to the DPUs.

### BRIEF DESCRIPTION OF DRAWINGS

FIG. 1 illustrates a system that is subject to embodiments for seamless offload of workload to data processing units (DPUs) based, at least in part, on capabilities associated with a selected first one of the DPUs being within a threshold;

FIG. 2 illustrates aspects of a system for seamless offload of workload to DPUs based, at least in part, on capabilities associated with a selected first one of the DPUs being within a threshold, according to at least one embodiment;

FIG. 3A illustrates further aspects of a discovery phase for seamless offload of workload to DPUs, according to at least one embodiment;

FIG. 3B illustrates still further aspects of an operation phase for seamless offload of workload to DPUs, according to at least one embodiment;

FIG. 4 illustrates computer and processor aspects of a system for seamless offload of workload to DPUs based, at least in part, on capabilities associated with a selected first one of the DPUs being within a threshold, according to at least one embodiment;

FIG. 5 illustrates a process flow in a system for seamless offload of workload to DPUs based, at least in part, on capabilities associated with a selected first one of the DPUs being within a threshold, according to at least one embodiment;

FIG. 6 illustrates yet another process flow in a system for seamless offload of workload to DPUs based, at least in part, on capabilities associated with a selected first one of the DPUs being within a threshold, according to at least one embodiment; and

FIG. 7 illustrates a further process flow in a system for seamless offload of workload to DPUs based, at least in part, on capabilities associated with a selected first one of the DPUs being within a threshold, according to at least one embodiment.

### DETAILED DESCRIPTION

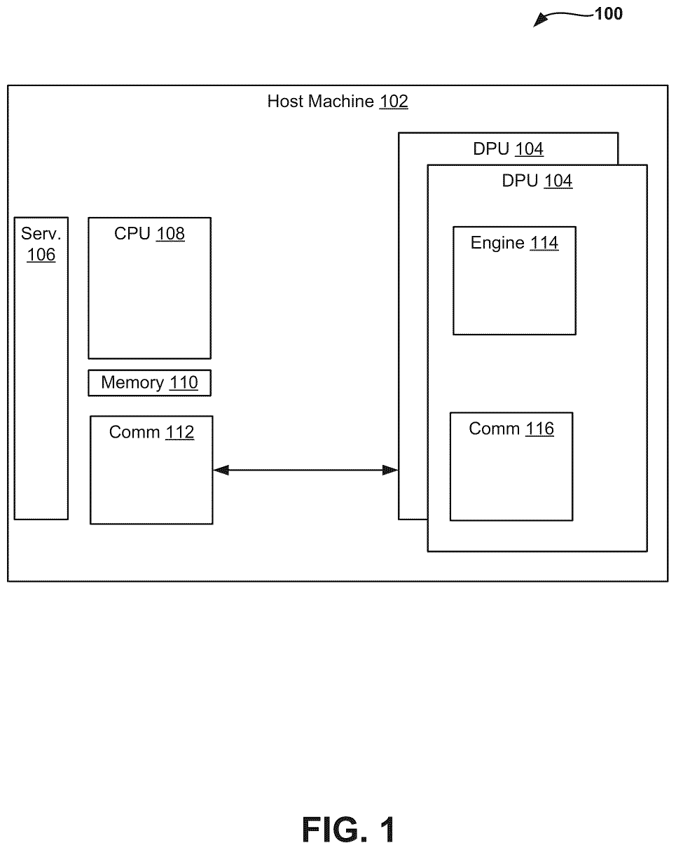

FIG. 1 illustrates a system 100 that is subject to embodiments for seamless offload of workload to data processing units based, at least in part, on capabilities associated with a selected first one of multiple data processing units (DPUs) being within a threshold, as detailed herein. DPUs are also referred to herein as DPU cards, unless indicated otherwise. Further, workload, as used herein, is in reference to data, applications, or programs to be executed, processed, or performed using one or more of a CPUs, graphics processing units (GPUs), or DPUs. The workload may pertain to networking and communication (data transfer), data reduction (compression/decompression), data security and analytics (cryptography), and data processing, generally.

In at least one embodiment, a system 100 for seamlessly offloading workload to multiple DPUs 104 uses a library, such as library definitions from a support library, and uses at least one processor 108 of a host machine 102 to receive a selection for a first one of the multiple DPUs 104. The at least one processor 108 can perform a background operation using library definitions from the library to select second ones of the DPUs to perform the workload in a load balancing arrangement together with the first one of the DPUs. Therefore, the at least one processor may be used herein to cause load balancing by bonding together multiple DPU cards at a library level to provide seamless data processing across the multiple DPU cards. This will allow the DPU cards to surpass the bandwidth and processing limitations of a single DPU card.

In at least one embodiment, the background operation is based, at least in part, on capabilities that are within a threshold and are associated with the first one of the DPUs. In at least one embodiment, a DPU used herein may be Nvidia's BlueField® DPU. Nvidia's DOCA®-related applications interface with a DOCA® library that may be associated with application programming interfaces (APIs) to enable applications for the BlueField® DPU. The DOCA® library is a support library that enables different types of complex applications, including cryptography (such as, using SHA1, SHA256, SHA512, or other approaches), compression/decompression (such as, using Deflate, LZ4, or other approaches), acceleration (such as, using RegEx), DMA (direct memory access) transfers, and visualization.

However, different DPUs, including different versions, have different silicon capabilities to support different ones of the complex applications listed above. For example, the silicon capabilities include different clock speeds, cache, and other aspects to provide different processor binnings. For example, hardware revisions or versions may include such information or be associated with such information, and such different capabilities may lead to different performance results for different ones of the complex applications. A DOCA®-related application may include scripts to select a first one of the connected DPUs to perform a workload. Separately, a user input, APIs, or a reference application may be also associated with the DOCA® library and may cause a background operation of a script that can perform background queries pertaining to the other DPUs associated with a CPU to perform at least part of the DOCA®-related application.

In at least one embodiment, the background operation can realize capabilities of the different DPUs as within a threshold of the selected one DPU. For example, a DPUs capabilities to perform cryptography may be different from the capabilities to perform compression/decompression. The background process can determine second ones of the DPUs to perform the workload, based in part on capabilities associated with the first one of the DPUs selected and where the capabilities are limited by a threshold. For example, if the application associated with the workload uses RegEx, the selected DPU may be one that offers RegEx support. Then, other DPUs also offering RegEx support may be realized by a background operation and a load balancing arrangement of the selected first one of the DPUs and of the realized second ones of the DPUs can altogether perform the workload without having to involve the user or the application to perform the load balancing.

In at least one embodiment, seamless offload at a library level that is based, at least in part, on capabilities associated with a selected first one of the DPUs being within a threshold, can resolve issues experienced by developers using the library to improve throughput of hardware to perform a workload. In one example, the performance of the hardware of each DPU card may be improved, but this approach may be limited by silicon availability to each DPU card. There may be a lot of features needed to be packed onto silicon of a DPU card, which remains limited by the silicon size. The system and method herein also address issues of the use of multiple hardware queue-pairs (QPs) on a DPU card to provide load balancing, the use multiple software threads, the use application-assigned CPU affinity and non-uniform memory access (NUMA) regions, and the use of out-of-order hardware QP processing.

For example, instructions relating to a workload may be queued and informed to a host channel adapter (HCA) using buffers having queues to be sent or received. These instructions may be structures of work requests or work queue elements that are pointers to a buffer. These structures may be in a send queue to point to message to be sent whereas the structures may be in a receive queue to point to where a message to be received may be placed. A weight may be determined for current traffic in the hardware QPs, for each queue, where the weight assignment determines load balancing. However, such a process involves multiple hardware QPs that are still limited by silicon availability. A similar issue is also the case with the use of an out-of-order hardware QP processing.

As to the use multiple software threads, this approach applies multithreading, in which instructions may be divided into threads to be executed in parallel. Load balancing applied here may attempt to make equal execution times for each of such threads. However, the use of multiple software threads may not optimize the system underlying such parallel operations. Further, application-based CPU affinity and NUMA regions require specific architecture for faster memory access time based, at least in part, on a memory location relative to a processor so that a process can access local memory at the faster memory access time than non-local memory. Like in the hardware QPs, these features also rely on a single DPU card. The silicon limitations imply that their throughput and processing capacity may always be physically upper-bounded because of the single DPU card used.

Therefore, workload performed by a single DPU or by DPUs selected by a user to be in a load balancing arrangement may not imply that the single DPU or that the selected DPUs match up to the capabilities required to perform the workload. For example, having generalized CPU affinity and NUMA regions may not be beneficial to certain applications and the use of multiple hardware queue-pair on a DPU, multiple software threads on a DPU, or out-of-order hardware queue-pair processing are all based on a single DPU and so, their throughput is limited to 50 gigabits/s (Gbps), whereas demands are being made for 200 Gbps of throughput for aspects of prior generation DPUs.

In at least one embodiment, the system and method herein eliminates a need to use a single DPU or expect a user to select the DPUs for load balancing of a workload; and instead, an application programming interface (API) or reference application that is associated with a library provides library definitions that may be used to determine the DPUs to be in a load balancing operation to perform the workload. The library definitions may be called in a background operation and can realize capabilities of other ones of the DPUs that are then registered based, at least in part, on capabilities of the selected DPU and based on a limitation made by a threshold. The selected DPU and the realized DPUs may be together in a load balancing arrangement.

In at least one embodiment, a DPU card can perform various operations in hardware by pre-arranged silicon features, instead of relying on software, to meet the 200 Gbps of throughput that may be required for some applications, such as for RegEx. The associated DPU cards may be enumerated at startup so that a host machine's CPU is aware of its connected resources. The DPU card may be used to offload certain workloads. Different than load balancing issues described earlier, the CPU may query a registry of the different DPU cards enumerated during startup. In at least one embodiment, capabilities of the DPU cards may be known by a version (or revision) and by other aspects stored within a registry to identify and provide further information for each DPU card.

In at least one embodiment, the system and method allows a user to select a DPU card with a capability, then at library definition may be called to run a background operation, which can check and register DPU cards. The registry of the DPU cards may be provided within the library, which may be a support library. Further, there may be a separate registry for DPU cards that physically attached to a system but that are not registered to be in a load balancing arrangement. A threshold may be used to limit the capability used from the selected DPU to check all the registered DPU cards. Further, reference to a singular threshold is applicable in the plural if it is being applied to limit multiple capabilities. The select DPU card and other DPU cards determined from the background process may be based, at least in part, on the capability and the threshold. For example, a workload may be sent to an instance of a support library associated with a DPU card in the load balancing arrangement. Each of the DPU cards has its own instance of the support library. This allows a host machine to understand how much of the DPU cards are being used at any time to perform a workload.

In at least one embodiment, the support library may include libraries associated with different DPU cards and with different types of applications. A background operation may use library definitions associated with the different DPU cards to determine similar capabilities that are within a threshold to a select DPU card. For example, the threshold may include a revision threshold for a revision capability, a silicon structure threshold (such as, a number of transistors, binnings, and related aspects) for a silicon structure capability, a clock threshold for a clock capability, a cache threshold for a cache capability, a cores threshold for a cores capability, a throughput threshold for a throughput capability, a bandwidth (such as, for communication) threshold for a bandwidth capability, and an application threshold for a native application capability. For example, Nvidia's BlueField® (BF) series are DPUs that have different revisions over time. BF2 is a revision that may be capable of 200 Gbps bandwidth, with native cryptography, compression, and RegEx applications. BF3 is a further revision that may be capable of operating at 400 Gbps bandwidth, with additional native support for telecommunication, artificial intelligence (AI), and high performance computing (HPC) applications. Further, BF2's capabilities may not be supported in BF3 and BF2 may demonstrate reduced performance relative to BF3 when performing non-native applications.

When a select DPU is to perform RegEx, for instance, the background operation is able to query a registry of enumerated DPUs and is able to determine other DPUs that support RegEx capabilities with similar performance threshold, for instance, as the select DPU. Then the select DPU and the other DPUs of similar capabilities that are limited by the threshold (including the performance threshold) may be separately registered in a registry of a library and may be placed in a load balancing arrangement to perform a workload. In addition, during performance of a workload, it is possible to add further DPUs to perform the workload. In at least one embodiment, it is also possible to allocate a higher portion of the workload to the DPUs that have capabilities within a first of two thresholds, whereas other DPUs of the load balancing arrangement that have capabilities outside the first of two thresholds, but within the second threshold, will receive a reduced portion of the workload.

In at least one embodiment, an application may rely on APIs, such as from a library that is a support library and that may include library definitions, to perform query and registering aspects of the DPU cards within the library. The library definitions may be for revisions of the DPU cards can include support for certain types of cryptography, reflecting a capability, and only certain types of cryptography, reflecting a threshold (such as, SHA1, SHA5256, and SHA512 that are supported in BF2); and certain types of compression, reflecting a further capability, but only to certain types of compressions, reflecting a threshold (such as, Deflate and LZ4 that are supported in BF2, whereas BF3 may support cryptography, but does not support SHA-type cryptography and may support further compression capabilities than in the threshold of BF2). In at least one embodiment, queries may be in the form of generic PCIe messages that are provided to the library and that may receive a response that is interpreted by the library. In at least one embodiment, the library definitions may interpret the message and may provide a Boolean response to the background operation to allow the background operation to determine DPU cards to be used with a select DPU card.

In at least one embodiment, the support library may be started as part of the system startup. Further, the system may initially run in a hot-path or discovery phase, where only data processing is performed for discovering capabilities to be associated in load balancing arrangement. A load balancing table and a library registry may be built in this phase or may be populated in this and in the operations phase. In one example, a user may not be able to see or need not understand the details of the registered DPU cards. Instead, each DPU card may cause a registry of a device API in the library, which may be called in the discovery phase to indicate a selection and which may be queried to determine DPUs to be used with capabilities that are within a threshold of a selected DPU card.

Thereafter, the support library may be started to process a workload using the selected DPU card. In the meantime, a device API of the support library, in the background, performs the background operation to update the registry to include more DPU cards that are within the capabilities and the threshold. This may occur as part of the discovery phase or may occur in a subsequent phase that is an operations phase or before the operations phase. The operations phase may be the phase in which a workload is performed. However, discovery may occur even in the operations phase during initialization of the workload to be performed or based in part on updates to the DPU cards.

FIG. 1 illustrates a system 100 that is subject to embodiments for seamless offload of workload to data processing units (DPUs) at a library level based, at least in part, on capabilities associated with a selected first one of the DPUs being within a threshold. The system 100 may include a host machine 102 having a CPU 108, having memory 110, having a communications feature 112, having a services feature 106, and having an association with a DPU 104. The DPU 104 may be a single DPU having an engine 114 to perform limited and specific native applications and may include a further communications feature 116 to communicate with the host machine's communications feature 112. The communications features 112, 116 in the system 100 may communicate there between based, at least in part, on the PCIe (peripheral component interconnect express) standard.

In at least one embodiment, the system 100 therefore includes at least one processor 108 and memory 110 having instructions that when executed by the at least one processor 108 causes the system to perform functions associated with seamless offload for load balancing in computer networks. The CPU 108 boots up to allow aspects of the DPU 104 to perform in the hot-path or discovery phase. This may be a reduced or restricted cache phase for performing critical checks, including discovery and verification of the applications.

Once discovered, the DPU 104 may be addressed with an identifier and may have an associated API to be used for performing native applications associated with the workload. The DPU 104 may be ready to receive workloads for performing in an operations phase. In at least one embodiment, the DPU 104 may be accessed from the host machine 102 (generally by the CPU 108) via secure shell (SSH), via a console, or via out-of-band (OOB) SSH using a network adapter, such as a 1 GbE OOB management port or uplink interfaces that is associated with the DPU 104. The console access may be through a dedicated port, such as an RS232® port, as part of an RShim driver access. However, the console access may also be via an RSHIM interface via dedicated USB port using another RShim driver that can access the DPU 104 from an external host machine that is other than the host machine 102.

In at least one embodiment, an operating system (OS) image that is different from an OS of the host machine 102 may be associated with the DPU 104 and may include further drivers and applications to manage the DPU card 104 independent of the host machine 102. In at least one embodiment, installation or modification is possible to the OS image of the DPU 104, which may include an ARM-based architecture and a bootup or setup utility for access via a console. In at least one embodiment, the DPU 104 may present further interfaces, including a GOB RJ-45 interface and optical ports for pX, pfXhpf (Host Physical Function) that is accessible to the host machine 102), pfXvfY (host virtual function to act as a single-root input/output virtualization (SR-IOV), which provides virtual network communication without the CPU 108, for the host machine 102), pXm0 (for the afore-referenced PCIe to access the DPU card 104), and pfXsf0 (for a further PCIe sub-function representation of the pXm0).

Such afore-referenced features may be part of one or more of the communications features 112, 116 to be between the host machine 102 and the installed DPU card 104 or is generally available on the DPU card 104. The DPU card 104 may include, as part of the communications feature 116, a virtual switch to enable one or more of such communications features 116. One or more of the communications features 116 of the DPU card 104 enable application emulation for a software-defined storage (SDS) to provide dedicated servers as physical disks.

In at least one embodiment, DPU 104 may be used to offload, accelerate, and isolate workloads so that the CPU 108 has lesser burden. In the offload aspect, infrastructure tasks may be offloaded from the host machine 102 so that the CPU may be used to run applications via provided services 106. Further, with the accelerate aspect, infrastructure functions are accelerated by native applications of the DPU 104 and are also accelerated faster than the CPU 108, at least because of the hardware acceleration in the silicon. In the isolate aspect, workload and control are separated as different domains of the DPU 104. This is to reduce burden on the CPL 102, from the workload, but also to protect the workload in case a security compromise at the CPU 102.

In at least one embodiment, a DPU 104 can receive an offloaded workload from a standard application operating otherwise on n number of server X86 cores. The DPU 104 may include n or 2n ARM-based cores with acceleration added to further improve a workload performance. The DPU includes acceleration by virtue of at least its silicon features for data movement, such as, using remote direct memory access (RDMA) to accelerate data movement between the host machine 102, the DPU 104, and also to other host machines; and for performing AI, HPC, big data, and storage workloads. The DPU 104 can provide the control aspects via its silicon features as well.

In at least one embodiment, a DPU 104 can be caused to inspect network traffic, to block attacks, and to provide encrypted transmissions. The DPU 104 can perform these aspects without CPU intervention. Further, in the isolation aspect, the DPU 104 operates separately from the CPU 108 and so, if the CPU 108 is compromised, the DPU 104 can detect or block malicious activity for the host machine 102 without CPU intervention. The DPU 104 may be caused to perform such functions using its silicon architecture.

In at least one embodiment, functions described herein, including cryptography, compression, and RegEx may be natively programmed for a DPU 104. The DPU 104 may include routing rules, flow tables, encryption keys, and network addresses that may be subject to change from time to time as part of security features of a control plane that are distinct from the data plane. Data plane functions, such as offload methods, encryption algorithms, and transport mechanisms are rules and algorithms that can be coded into silicon after they are standardized and established. The control plane rules and programming may be run on an FPGA or in a programmable (software) aspect of the DPU 104.

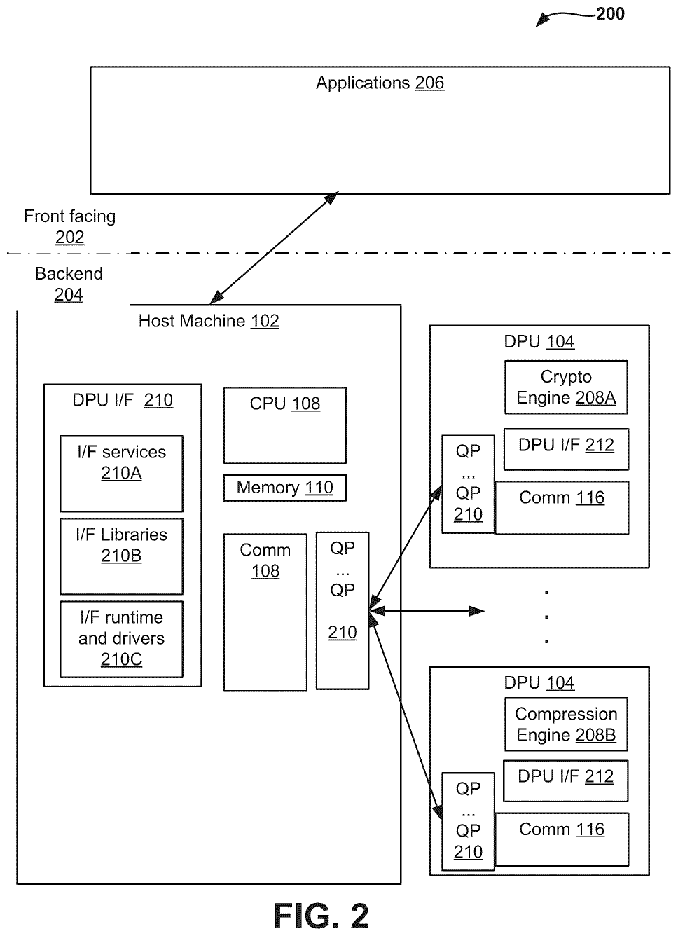

FIG. 2 illustrates aspects of a system 200 for seamless offload of workload to DPUs based, at least in part, on capabilities associated with a selected first one of the DPUs being within a threshold, according to at least one embodiment. In at least one embodiment, a workload to be performed by DPUs 104 in a load balancing arrangement may be provided or caused, at least in part, by input from one of many applications 206 on a front-end side 202 of a host machine 206. In at least one embodiment, an application may include or may be associated with instructions to be performed, at least in part, by a CPU 108 and, at least in part, by the DPUs 104.

A software framework, such as DOCA®, may provide the relationships indicated in FIG. 2 to enable applications 206 to have their workload performed on the DPUs 104. For example, the applications 206 of the front-end side 202 may make use of a DPU interface 210 to offload infrastructure workloads from CPU 108 and to accelerate the workloads with the DPUs 104 in a load balancing arrangement. This enables hardware accelerated performance by the DPUs based, at least in part, on their capabilities and the thresholds described herein, where at least part of the DPUs are determined to be in the load balancing arrangement by a back-end side 204 operation.

In at least one embodiment, a DPU or DPU card 104 may include a SmartNIC (Network interface controller) as part of its communication features 116, other than PCIe, to communicate with one or more other host machines. The DPU card 104 is able to use fast Ethernet® or InfiniBand, (IB) in its communication. The DPU 104 may include multiple ARM-based cores, dynamic random access memories (DRAM), and a PCIe switch. An embedded ConnectX SmartNIC may be provided to support multiple accelerators (such as, for networking, for cloud computing, for storage, for encryption, for media streaming, for compression, and for time synchronization, among other available features).

In at least one embodiment, there may be further accelerators and features for security, storage virtualization, hardware isolation, and remote management. However, different DPU revisions may include different silicon architecture to support different native applications, represented as the different engines 208A-N. While the illustration in FIG. 2 is as to different engines 208A, there are other capabilities throughout herein that may be provided by such different DPUs 104 at different performance levels. Therefore, capabilities may include an ability to perform a native application or may include an ability to perform any application with different levels of performance, such as a non-native level of performance.

The DPU interface 210 may include software development and runtime platform features, along with aspects within the DPUs 104 to support selection using a user input, to support querying from a background operation of the host machine 102, and to support the DPUs being placed in a load balancing arrangement to perform a workload. In at least one embodiment, the DPU interface 210 includes aspects of a software development kit (SDK) to enable the applications 206 to have their workload performed by DPUs 104 in a load balancing arrangement. The SDK may include interface services 210A with developer tools and reference application sources, including APIs; interface libraries 210B that include support libraries; and interface runtime and drivers 210C that include reference application executables and runtime tools.

In at least one embodiment, the interface runtime and drivers 210C include drivers to support the support libraries 210B, which in turn support the reference applications of the interface services 210A. The DPUs 104 may each include similar SDKs in their respective DPU interfaces 212. The DPU interfaces 212 of the DPUs 104 may be able to provide telemetry and management tools for the respective DPUs 104. Further, the DPU interface 210 of the host machine 102 can program software-defined networking (SDN) for the data plane (that can be accelerated) or for the control plane. In at least one embodiment, a DPU interface 212 in each DPU card 104 may communicate with its respective engines 208A; 208B. A DPU interface 210 of a host machine, however, can communicate with all the different DPU engines 208A-B. A workload to be performed by DPUs 104 in a load balancing arrangement may use multiple engines in each DPU to perform the workload.

In at least one embodiment, one or more applications 206 can provide the workload for the DPUs 104 and represent instructions that are at least partly executable on the CPU 108 and partly on the DPUs 104. The applications may include routines to indicate aspects of the applications to be executed on one or a combination of the CPU 108 and the DPUs 104. In at least one embodiment, the applications 206 executing on a CPU 108 of a host machine 102 may be compiled for the CPU (such as for an X86 instruction set), while applications having aspects executing on the DPUs 104 may be compiled for an ARM-based instruction set. The DPU interface 210 provides library definitions for backend operations to perform seamless offloading and acceleration of aspects of the applications 206 to be performed on the DPUs 104 in a load balancing arrangement.

In at least one embodiment, an application 206 uses at least one of the support libraries and APIs for execution on one or more of the CPU 108 or the DPUs 104, where the DPUs 104 are to be in a load balancing arrangement. Whereas a main aspect of one of the applications 206 may run on the CPU 108, a software agent allows other aspects of the application to run on the DPUs 104, in a load balancing arrangement, by activating hardware offloads. In at least one embodiment, an application 206 may provide an input interface to receive a selection of a first one of the DPUs 104 to perform a workload. The selection may be from a user input, a reference application, or an API.

In at least one embodiment, an application 206 may include script or may be associated with an API requiring a specific DPU to be selected for its capabilities. Then, the DPU interface 210 may cause a background operation to be performed on the CPU 108 or other processing unit of the host machine. The background operation may use library definitions from the support libraries 210B to select second ones of the DPUs 104. The selection by the background operation may be based, at least in part, on capabilities associated with the first one of the DPUs 104 being within a threshold. Then, the CPU 108 or the first one of the DPUs 104 can cause the first one and the second ones of the DPUs 104 to be in a load balancing arrangement to perform the workload. However, a first selected DPU may use its DPU interface 212 to perform a background operation to poll and select other DPUs to be part of the workload and to then inform the CPLT to update its registry and its load balancing table.

In at least one embodiment, an application 206 includes instructions to the DPUs 104 to access the drivers of the DPU interface 210 directly. This may require low-level programming but may be implemented by APIs or library definitions in the interface libraries 210B. Therefore, the interface libraries 210B provide high-level abstractions of the drivers, without a need for user intervention to understand the capabilities of the DPUs 104 and to further understand the specific capabilities of the applications 206. Instead, based, at least in part, on a selection of a first DPU, the other DPUs having similar capabilities as the first DPU and where such capabilities are within a threshold may be selected. A reference to a threshold in the singular is understood to imply multiple thresholds as required to enable operation of the system, such as the systems 100-350 in FIGS. 1-3B, herein.

In at least one embodiment, reference applications may be provided in the interface services 210A, which may represent actual working code of examples to use the library definitions of the libraries 210B. In at least one embodiment, to build an application 206 capable of taking advantage of an accelerated load balancer or to integrate an agent to execute on multiple DPUs 104, the deep packet inspection (DPI) libraries may be modified to include a load balancing library definition. The support libraries can run on top of a data plane (DP) library and can use a state connection for tracking and for RegEx performed by at least the select first DPU 104.

In at least one embodiment, an application may be developed to use the SR-IOV to create multiple virtual functions, which may include host-to-virtual mappings between the CPU 108 and the DPUs 104. The DP libraries may be run as an instance, along with the interface libraries 210B for each of the DPUs 104 in the load balancing arrangement. In at least one embodiment, therefore, the background operation uses a reference application or an application programming interface (API) associated with a support library. The support library may be provided as instances, each having library definitions to provide a response to a query that may be associated with an application 106. For example, the background operation includes a query to the DPUs 104 based, at least in part, on the capabilities and the threshold.

In at least one embodiment, an API or library definition to perform the background operation may be provided to be within the library interface 210B. In at least one embodiment, the DPU interface 210 may therefore include SDK components (in the services and the libraries 210A, 210B) to build applications that run on or use the DPU and are capable of initiating a library definition to perform the background operation. The SDK components may include runtime aspects (in the runtime and drivers 210C) to cause applications to include instructions to provide a user with a requirement to select a DPU and to perform the background operation to selected other DPUs based, at least in part, on the capabilities and the threshold associated with the selected DPU.

In at least one embodiment, therefore, the runtime may include binary form of libraries, runtime binaries, compiler tools, installation utilities, benchmarks, and various service agents, whereas the services and the libraries may include the development versions of the libraries, drivers, and toolkits, as well as documentation and reference code sources for reference applications. The runtime 210C may also include management aspects to provision and support the multiple DPU cards in a load balancing arrangement. In at least one embodiment, a routing policy library definition may be used to cause a first of the DPUs 104 to perform redirection of traffic from a CPU 108 to the DPUs 104 in the load balancing arrangement.

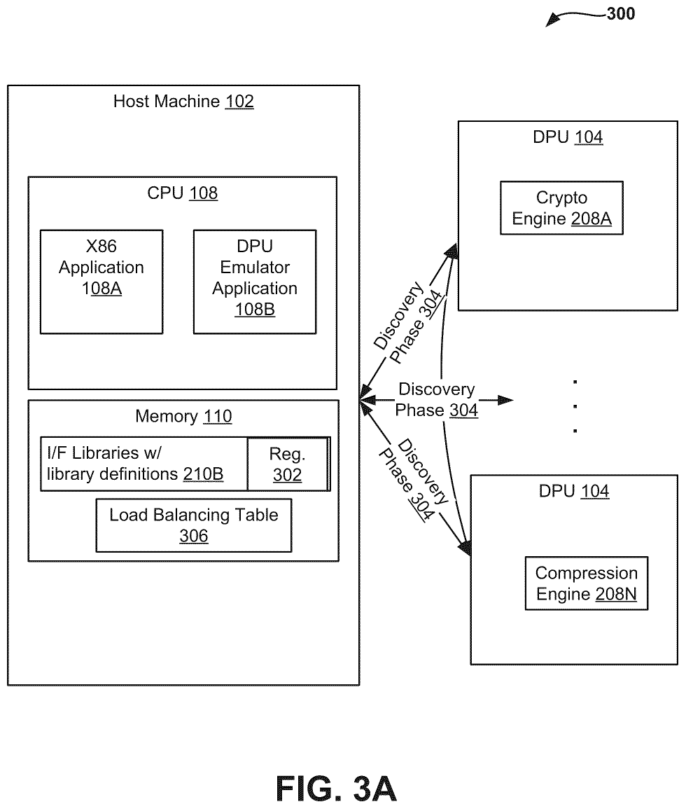

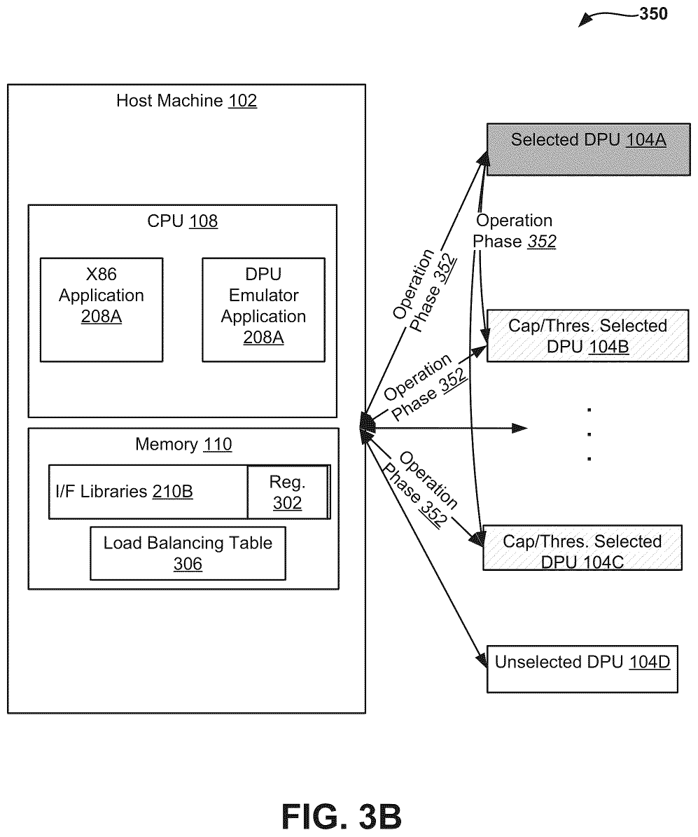

FIG. 3A illustrates further aspects 300 of a discovery phase for seamless offload of workload to DPUs, according to at least one embodiment. In the discovery phase 304, network communication to the host machine 102 may flow through a virtual switch (of a control plane) provided by one or more of the DPUs 104. The network communication may be provided between the host and the DPUs 104, where each of the DPUs 104 may be in a trusted relationship and may be subject to managed by an administrator. In this mode, it is possible to load network drivers, perform resets, updates, and to change the mode of operation on the DPUs 104.

In at least one embodiment, on initiation of a host machine 102 and the DPUs 104, network communication to the host machine may only be performed when the DPUs 104 are initiated or loaded, following population of a registry 302 of the connected DPUs 104, for example. For example, in a discovery phase 304, the host machine receives a selection using a user input, a reference application, or an API, for a DPU to perform a workload. The host machine may perform the background operation to populate the registry of a support library. Once initiated or loaded, workload to the host machine 102 may be allowed to flow in an operation phase 352 to the one or more DPUs in FIG. 3B.

The workload to the host machine 102 or from the host machine 102 may use representors to communicate between the host machine and the DPUs 104, where packets associated with the host machine 102 are handled by the DPUs 104 or by the virtual switch of the DPUs 104. A virtual switch can allow seamless offloading of traffic based, at least in part, on a load balancing table 306 that may be populated in the discovery phase 304. Further, the host machine or even a selected DPU may perform polling of the other DPUs in the discovery phase 304 or during performance of the workload in an operations phase 352 to cause additional DPUs to be added to the load balancing arrangement by registering those DPUs and their capabilities in the registry and updating a load balancing table.

In at least one embodiment, the driver on the host machine 102 may be loaded after the drivers on the DPUs 104 have loaded and have completed configuration, including population of a registry 302. Further, memory configuration may be allocated by a function of the first DPU selected. The function of the first DPU selected may be to control and to configure the virtual switch so that traffic to and from the host machine 102 processes through the DPUs 104 in the load balancing arrangement.

In at least one embodiment, therefore, in the discovery phase 304, the DPUs 104 are registered in an initial background operation including queries to the DPUs 104, along with their capabilities. The background operation may rely on library definitions in an interface library 210B that includes a support library to enable such discovery between the CPU 108 and the DPUs 104. The CPU 108 enables a further background operation, in an operations phase, to be performed to query further capabilities of the DPLTs (other than a first DPL and other initial DPUs selected). This further query may be also based, at least in part, on the capabilities and the threshold associated with the first DPU 104. In at least one embodiment, the system 200 is able to poll, in periodic intervals, capabilities associated with the DPUs 104 (including to determine if new DPUs are added in the system 200). This may be the case when the capabilities are updated by software or other updates to a DPU card or the newly added DPU, for instance. Then, the capabilities in the support library may be updated and may be available to update a load balancing table.

In at least one embodiment, instead of an X86 application 108A of a CPU 108, it is possible to emulate applications for execution in the DPUs 104 using the load balancing arrangement. For example, PCIe devices, like the DPUs 104 may be represented in the system 200 by emulated applications 108B. This may be performed by a controller software of the first one of the DPUs 104. The DPUs 104 in the load balancing arrangement may communicate with the CPU 108 as emulated devices, in at least one embodiment.

FIG. 3B illustrates still further aspects of an operation phase 352 for seamless offload of workload to DPUs, according to at least one embodiment. In at least one embodiment, the support library is enabled to be in the operation phase 352. The background operation may be performed to query further capabilities of the DPUs 104 from the registry 302 using the support library in the discovery phase or the operation phase. A load balancing table 306 may be built to allocate the workload for the first one 104A and the second ones 104B, C of the DPUs 104. In at least one embodiment, even if illustrated from the CPU 108, aspects of the discovery phase 304 and of the operation phase 352 may be performed from the first selected DPU 104A.

In at least one embodiment, the capabilities and the threshold include two or more of hardware revision, binning information, clock frequency, or throughput. Further, first hardware capability of first one 104A of the DPUs 104A in the load balancing arrangement may be determined in the operation phase 352. Second hardware capabilities of second ones 104B, C of the DPUs in the load balancing arrangement, may be determined. Then, it is possible to enable the workload to be distributed, in the load balancing arrangement, to the first one 104A and second ones 104B, C of the DPUs 104 that are already in the load balancing arrangement (such as to not include the DPU 104D that is unselected). This is so that some DPUs that are closer to the capabilities (in a first range of the threshold) because it their first hardware capabilities get more portion of the workload than other DPUs that are away from the capabilities (in a second range of the threshold).

In at least one embodiment, the system and method herein include building a load balancing table of the first one and the second ones of the DPUs 104. Then, workload is allocated, where at least one 104B of the second ones 104B, C of the DPUs 104 includes features that are in a first range within the threshold of the capabilities associated with the first one 104A of the DPUs 103 and wherein another 104C of the second ones of the DPUs 104B, C includes features that are in a second threshold range within the threshold of the capabilities associated with the first one 104A of the DPUs 104.

In at least one embodiment, the system and method herein include building a load balancing table of the first one 104A and the second ones 104B, C of the DPUs 104 to allocate the workload. This is so that a first time to perform the workload is allocated to at least one 104B of the second ones 104B, C of the DPUs 104 and a second time to perform the workload is allocated to another 104C of the second ones 104B, C of the DPUs 104. The first time is more than the second time thereby providing more workload allocation to the one (such as, DPU 104B) of the second ones of the DPUs than the others (such as, DPU 104C). In at least one embodiment, the capabilities and the thresholds may be associated with hardware and software features for one or more of data compression, data encryption, or regular expression operations.

In at least one embodiment, the system 100-350 herein is for seamless offload of a workload to multiple DPUs 104, where one or more processing unit 108; 104 of the system, can receive a selection of a first one 104A of the DPUs 104 to perform the workload. The one or more processing unit 108; 104 perform a background operation using library definitions in a library 210B to select second ones 104B, C of the DPUs 104 based, at least in part, on capabilities associated with the first one 104A of the DPUs being within a threshold. The workload is to be performed in a load balancing arrangement of the first one and second ones 104A-C of the DPUs 104.

In at least one embodiment, the one or more processing unit 108; 104 can perform the background operation using a reference application or an application programming interface (API) associated with a support library, such as within a library 210B. The library 210B includes the library definitions and the background operation includes a query to the DPUs 104 based, at least in part, on the capabilities and the threshold. In at least one embodiment, the system and method herein include aspects to register capabilities of the DPUs 104 in a support library, such as a registry 302; and include aspects to perform the background operation to query the DPUs using their capabilities and based, at least in part, on the capabilities and the threshold associated with the first one 104A of the DPUs 104.

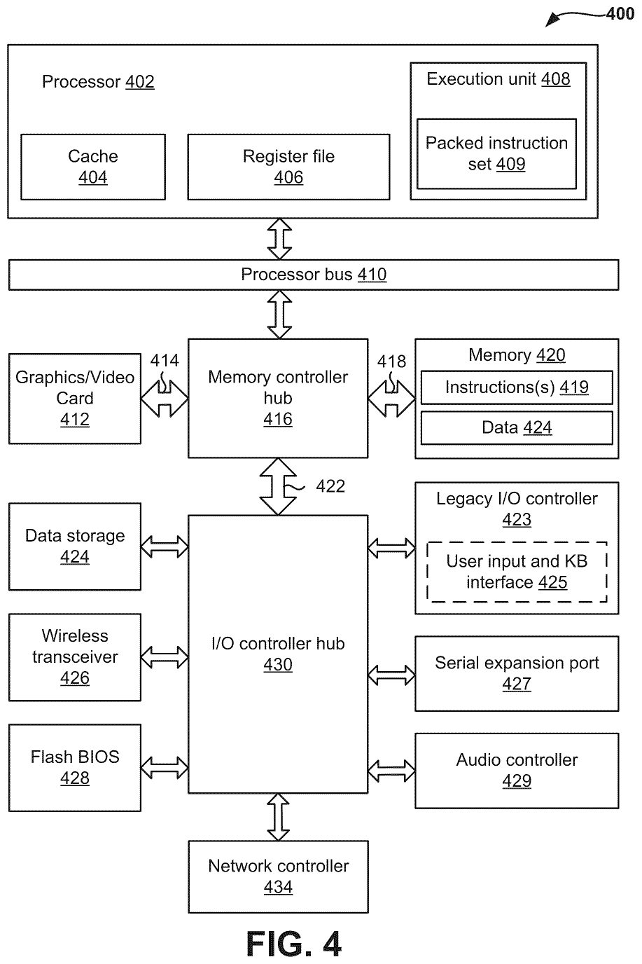

FIG. 4 illustrates computer and processor aspects 400 of a system for seamless offload of workload to DPUs based, at least in part, on capabilities associated with a selected first one of the DPUs being within a threshold, according to at least one embodiment. The computer and processor aspects 400 may be performed by one or more processors that include a system-on-a-chip (SOC) or some combination thereof formed with a processor that may include execution units to execute an instruction, according to at least one embodiment. Such one or more processors may include CPUs and GPUs. Further, the computer and processor aspects may be within one or more of the controller 408 or the adapter 406.

In at least one embodiment, the computer and processor aspects 400 may include, without limitation, a component, such as a processor 402 to employ execution units including logic to perform algorithms for process data, in accordance with present disclosure, such as in embodiment described herein. In at least one embodiment, the computer and processor aspects 400 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, the computer and processor aspects 400 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, the computer and processor aspects 400 may include, without limitation, a processor 402 that may include, without limitation, one or more execution units 408 to perform aspects according to techniques described with respect to at least one or more of FIGS. 1-3B and 5-7 herein. In at least one embodiment, the computer and processor aspects 400 is a single processor desktop or server system, but in another embodiment, the computer and processor aspects 400 may be a multiprocessor system.

In at least one embodiment, the processor 402 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, a processor 402 may be coupled to a processor bus 410 that may transmit data signals between processor 402 and other components in computer system 400.

In at least one embodiment, a processor 402 may include, without limitation, a Level 1 (“L1”) internal cache memory (“cache”) 404. In at least one embodiment, a processor 402 may have a single internal cache or multiple levels of internal cache. In at least one embodiment, cache memory may reside external to a processor 402. Other embodiments may also include a combination of both internal and external caches depending on particular implementation and needs. In at least one embodiment, a register file 406 may store different types of data in various registers including, without limitation, integer registers, floating point registers, status registers, and an instruction pointer register.

In at least one embodiment, an execution unit 408, including, without limitation, logic to perform integer and floating point operations, also resides in a processor 402. In at least one embodiment, a processor 402 may also include a microcode (“ucode”) read only memory (“ROM”) that stores microcode for certain macro instructions. In at least one embodiment, an execution unit 408 may include logic to handle a packed instruction set 409.

In at least one embodiment, by including a packed instruction set 409 in an instruction set of a general-purpose processor, along with associated circuitry to execute instructions, operations used by many multimedia applications may be performed using packed data in a processor 402. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, an execution unit 408 may also be used in microcontrollers, embedded processors, graphics devices, DSPs, and other types of logic circuits. In at least one embodiment, the computer and processor aspects 400 may include, without limitation, a memory 420. In at least one embodiment, a memory 420 may be a Dynamic Random Access Memory (“DRAM”) device, a Static Random Access Memory (“SRAM”) device, a flash memory device, or another memory device. In at least one embodiment, a memory 420 may store instruction(s) 419 and/or data 421 represented by data signals that may be executed by a processor 402.

In at least one embodiment, a system logic chip may be coupled to a processor bus 410 and a memory 420. In at least one embodiment, a system logic chip may include, without limitation, a memory controller hub (“MCH”) 416, and processor 402 may communicate with MCH 416 via processor bus 410. In at least one embodiment, an MCH 416 may provide a high bandwidth memory path 418 to a memory 420 for instruction and data storage and for storage of graphics commands, data and textures. In at least one embodiment, an MCH 416 may direct data signals between a processor 402, a memory 420, and other components in the computer and processor aspects 400 and to bridge data signals between a processor bus 410, a memory 420, and a system I/O interface 422. In at least one embodiment, a system logic chip may provide a graphics port for coupling to a graphics controller. In at least one embodiment, an MCH 416 may be coupled to a memory 420 through a high bandwidth memory path 418 and a graphics/video card 412 may be coupled to an MCH 416 through an Accelerated Graphics Port (“AGP”) interconnect 414.

In at least one embodiment, the computer and processor aspects 400 may use a system I/O interface 422 as a proprietary hub interface bus to couple an MCH 416 to an I/O controller hub (“ICH”) 430. In at least one embodiment, an ICH 430 may provide direct connections to some I/O devices via a local I/O bus. In at least one embodiment, a local I/O bus may include, without limitation, a high-speed I/O bus for connecting peripherals to a memory 420, a chipset, and processor 402. Examples may include, without limitation, an audio controller 429, a firmware hub (“flash BIOS”) 428, a wireless transceiver 426, a data storage 424, a legacy I/O controller 423 containing user input and keyboard interfaces 425, a serial expansion port 427, such as a Universal Serial Bus (“USB”) port, and a network controller 434. In at least one embodiment, data storage 424 may comprise a hard disk drive, a floppy disk drive, a CD-ROM device, a flash memory device, or other mass storage device.

In at least one embodiment, FIG. 4 illustrates computer and processor aspects 400, which includes interconnected hardware devices or “chips”, whereas in other embodiments, FIG. 4 may illustrate an exemplary SoC. In at least one embodiment, devices illustrated in FIG. 4 may be interconnected with proprietary interconnects, standardized interconnects (e.g., PCIe) or some combination thereof. In at least one embodiment, one or more components of the computer and processor aspects 400 that are interconnected using compute express link (CXL) interconnects.

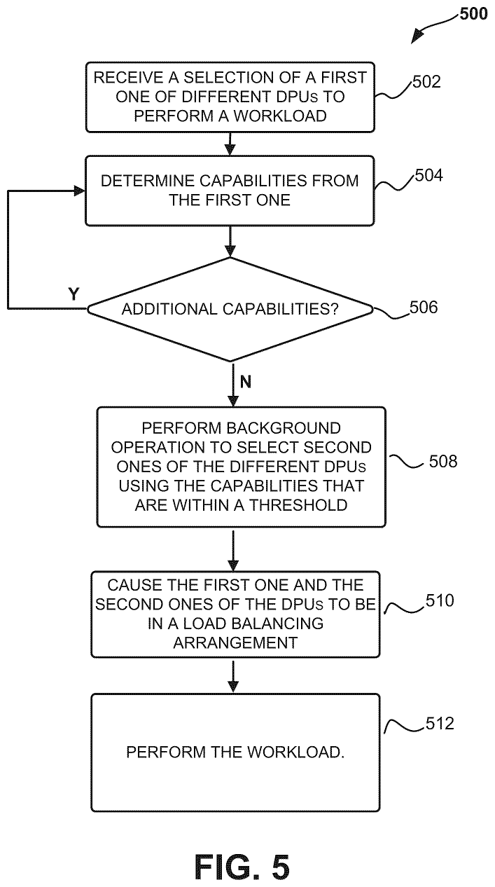

FIG. 5 illustrates a process flow or method 500 in a system for seamless offload of workload to DPUs based, at least in part, on capabilities associated with a selected first one of the DPUs being within a threshold, according to at least one embodiment. The method 500 includes receiving (502) a selection of a first one of provided DPUs to perform a workload. The method 500 includes determining (504) capabilities form the first one of the provided DPUs. The method 500 includes verifying (506) that all capabilities are determined by periodic checking for additional capabilities of the first one of provided DPUs. The method 500 includes performing (508) a background operation to select second ones of the provided DPUs based, at least in part, on capabilities associated with the first one of the plurality of DPUs being within a threshold. The method 500 includes causing (510) the first one and the second ones of the provided DPUs to be in a load balancing arrangement to perform the workload. The method 500 may further include performing (512) the workload using the load balancing arrangement of the first and the second ones of the provided DPUs from step 510.

In at least one embodiment, the method 500 may include a further step or may include a sub-step to perform the selection using user input, a reference application, or an application programming interface (API). A library definition may be associated with a support library and may be invoked by the user input, the reference application, or the API to enable the background operation that includes a query to the DPUs based, at least in part, on the capabilities and the threshold.

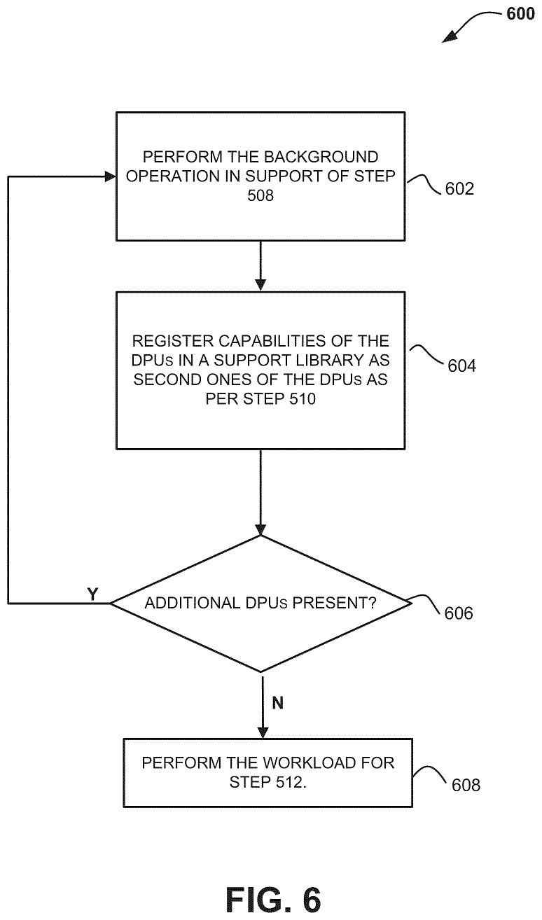

FIG. 6 illustrates yet another process flow or method 600 in a system for seamless offload of workload to DPUs based, at least in part, on capabilities associated with a selected first one of the DPUs being within a threshold, according to at least one embodiment. The method 600 includes performing (602) the background operation to query multiple DPUs in support of step 508. The method 600 includes registering (604) the capabilities of the provided DPUs in a support library to be the second ones of the DPUs, as in step 510. The method 600 may include verifying (606) that there are no further DPUs remaining to be queried. The method 600 includes performing (608) the workload for step 512 using the first DPU and the second ones of the DPUs. Further, the method 600 may use the queries based, at least in part, on the capabilities and the threshold associated with the first one of the DPUs, as part of the background operation, but may also continue to do so at different times, including when performing the workload in an operations phase of a system performing the method 600 herein.

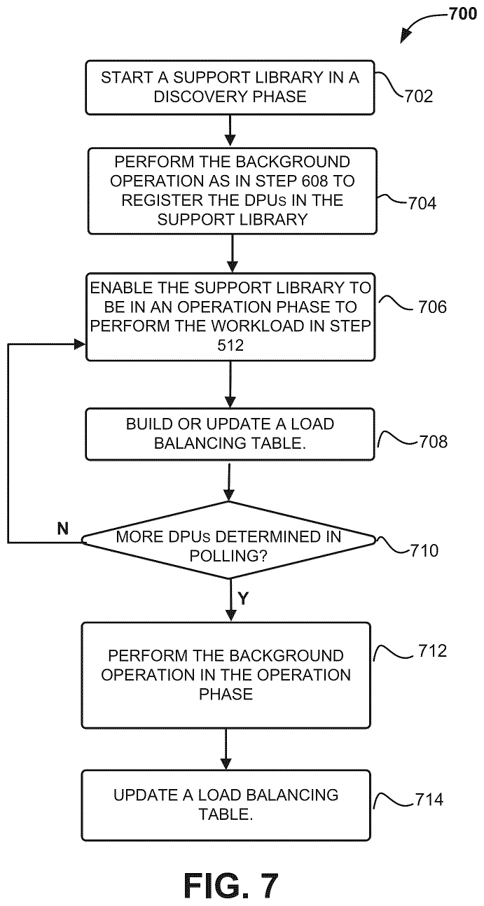

FIG. 7 illustrates a further process flow or method 700 in a system for seamless offload of workload to DPUs based, at least in part, on capabilities associated with a selected first one of the DPUs being within a threshold, according to at least one embodiment. The method 700 includes starting (702) a support library in a discovery phase. The method 700 includes performing (704) the background operation to register (704) individual ones of the DPUs in the support library. The registering may include providing capabilities associated with each of the DPUs within a registry of the support library, for instance. The method 700 includes enabling (706) the support library to be in an operation phase to perform the workload in support of steps 510, 512 of method 500 in FIG. 5. The method 700 includes building (708) a load balancing table for the allocation of the workload which allows step 512 to be performed. Further, the method 700 may include verifying (710), such as, by polling, if further DPUs are to be included in a load balancing arrangement. The method 700 includes performing (712) the background operation to query capabilities of the further DPUs using the support library in the operation phase. The method 700 includes updating (714) a load balancing table for the allocation of the workload so that step 512 may be performed using the updated load balancing table.

In at least one embodiment, the method 700 may include a further step or may include a sub-step to determine a first hardware capability of the first one of the DPUs and second hardware capabilities of the second ones of the DPUs as part of steps 702, 704, and 710. In at least one embodiment, the method 700 may include a further step or may include a sub-step to enable the workload to be distributed, in the load balancing arrangement, to the first one and second ones of the DPUs according to the first and the second hardware capabilities.

In at least one embodiment, the method 700 may include a further step or may include a sub-step for polling, in periodic intervals, capabilities associated with the DPUs, as part of step 710. The capabilities may be associated in a support library based in part on queries by the background operation. In at least one embodiment, the method 700 may include a further step or may include a sub-step to build or update the load balancing table in step 714 using at least one of the second ones of the DPUs that may include features that are in a first threshold range and that may include another of the second ones of the DPUs that may include features that are in a second threshold range. The first and the second threshold ranges may be within the threshold of the capabilities associated with the first one of the DPUs.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors.

In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. References may also be made to providing, outputting, transmitting, sending, or presenting analog or digital data. In at least one embodiment, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system comprising at least one processor and memory comprising instructions that when executed by the at least one processor cause the system to:
receive a selection of a first one of a plurality of data processing units (DPUs) to perform a workload;
perform a background operation to select second ones of the plurality of DPUs based, at least in part, on capabilities associated with the first one of the plurality of DPUs being within a threshold; and
cause the first one and the second ones of the plurality of DPUs to be in a load balancing arrangement to perform the workload.

2. The system of claim 1, wherein the memory comprising instructions that when executed by the at least one processor further cause the system to:
perform the selection using user input, a reference application, or an application programming interface (API), wherein a library definition associated with a support library enables the background operation that comprises a query to the plurality of DPUs based, at least in part, on the capabilities and the threshold.

3. The system of claim 1, wherein the memory comprising instructions that when executed by the at least one processor further cause the system to:
perform the background operation to query a plurality of capabilities of the plurality of DPUs based, at least in part, on the capabilities and the threshold associated with the first one of the plurality of DPUs; and
register the plurality of capabilities of the plurality of DPUs in a support library.

4. The system of claim 1, wherein the memory comprising instructions that when executed by the at least one processor further cause the system to:
start a support library in a discovery phase;
register individual ones of the plurality of DPUs in the support library;
enable the support library to be in an operation phase;
perform the background operation to query further capabilities of the plurality of DPUs using the support library in the discovery phase or the operation phase; and
build a load balancing table to allocate the workload for the first one and the second ones of the plurality of DPUs.

5. The system of claim 1, wherein the capabilities and the threshold include two or more of hardware revision, binning information, clock frequency, or throughput.

6. The system of claim 1, wherein the memory comprising instructions that when executed by the at least one processor further cause the system to:
determine first hardware capabilities of the first one of the plurality of DPUs and second hardware capabilities of the second ones of the plurality of DPUs; and
enable the workload to be distributed, in the load balancing arrangement, to the first one and second ones of the plurality of DPUs according to the first and the second hardware capabilities.

7. The system of claim 1, wherein the memory comprising instructions that when executed by the at least one processor further cause the system to:
poll, in periodic intervals, a plurality of capabilities associated with the plurality of DPUs, wherein the plurality of capabilities are associated in a support library.

8. The system of claim 1, wherein the memory comprising instructions that when executed by the at least one processor further cause the system to:
build a load balancing table of the first one and the second ones of the plurality of DPUs to allocate the workload, wherein at least one of the second ones of the plurality of DPUs comprises features that are in a first threshold range within the threshold of the capabilities associated with the first one of the plurality of DPUs and wherein another of the second ones of the plurality of DPUs comprise features that are in a second threshold range within the threshold of the capabilities associated with the first one of the plurality of DPUs.

9. The system of claim 1, wherein the memory comprising instructions that when executed by the at least one processor further cause the system to:
build a load balancing table of the first one and the second ones of the plurality of DPUs to allocate the workload, wherein a first time to perform the workload is allocated to at least one of the second ones of the plurality of DPUs and a second time to perform the workload is allocated to another of the second ones of the plurality of DPUs, and wherein the first time is more than the second time.

10. The system of claim 1, wherein the capabilities and the thresholds are associated with hardware and software features for one or more of data compression, data encryption, or regular expression operations.

11. A method for seamless offload of a workload to a plurality of data processing units (DPUs), comprising:
receiving a selection of a first one of a plurality of DPUs to perform a workload;
performing a background operation to select second ones of the plurality of DPUs based, at least in part, on capabilities associated with the first one of the plurality of DPUs being within a threshold; and
causing the first one and the second ones of the plurality of DPUs to be in a load balancing arrangement to perform the workload.

12. The method of claim 11, further comprising:
performing the selection using user input, a reference application, or an application programming interface (API), wherein a library definition associated with a support library enables the background operation that comprises a query to the plurality of DPUs based, at least in part, on the capabilities and the threshold.

13. The method of claim 11, further comprising:
performing the background operation to query a plurality of capabilities of the plurality of DPUs based, at least in part, on the capabilities and the threshold associated with the first one of the plurality of DPUs; and
registering the plurality of capabilities of the plurality of DPUs in a support library.

14. The method of claim 11, further comprising:
start a support library in a discovery phase;
register individual ones of the plurality of DPUs in the support library;
enable the support library to be in an operation phase;
perform the background operation to query further capabilities of the plurality of DPUs using the support library in the discovery phase or the operation phase; and
build a load balancing table to allocate the workload for the first one and the second ones of the plurality of DPUs.

15. The method of claim 11, further comprising:
determining a first hardware capability of the first one of the plurality of DPUs and second hardware capabilities of the second ones of the plurality of DPUs; and
enabling the workload to be distributed, in the load balancing arrangement, to the first one and second ones of the plurality of DPUs according to the first and the second hardware capabilities.

16. The method of claim 11, further comprising:
polling, in periodic intervals, a plurality of capabilities associated with the plurality of DPUs, wherein the plurality of capabilities are associated in a support library to be queried by the background operation.

17. The method of claim 11, further comprising:
building a load balancing table of the first one and the second ones of the plurality of DPUs to allocate the workload, wherein at least one of the second ones of the plurality of DPUs comprises features that are in a first threshold range within the threshold of the capabilities associated with the first one of the plurality of DPUs and wherein another of the second ones of the plurality of DPUs comprises features that are in a second threshold range within the threshold of the capabilities associated with the first one of the plurality of DPUs.

18. A system for seamless offload of a workload to a plurality of data processing units (DPUs), comprising:
one or more processing unit to receive a selection of a first one of the plurality of DPUs to perform the workload, and to perform a background operation to select second ones of the plurality of DPUs based, at least in part, on capabilities associated with the first one of the plurality of DPUs being within a threshold, wherein the workload is to be performed in a load balancing arrangement of the first one and second ones of the plurality of DPUs.

19. The system of claim 18, the one or more processing units are further configured to:
perform the selection using user input, a reference application, or an application programming interface (API), wherein a library definition associated with a support library enables the background operation that comprises a query to the plurality of DPUs based, at least in part, on the capabilities and the threshold.

20. The system of claim 18, the one or more processing units are further configured to:
perform the background operation to query a plurality of capabilities of the plurality of DPUs based, at least in part, on the capabilities and the threshold associated with the first one of the plurality of DPUs; and
register the plurality of capabilities of the plurality of DPUs in a support library.
